(19) United States
(12) Patent Application Publication
(10) Pub. No.: US 2025/0355974 A1
(43) Pub. Date: Nov. 20, 2025

(54) TRUSTED MULTI-LABEL CLASSIFICATION

(71) Applicant: NEC Laboratories America, Inc., Princeton, NJ (US)

(72) Inventors: Xujiang Zhao, Hillsborough, NJ (US); Yiyou Sun, Madison, WI (US); Haoyu Wang, Plainsboro, NJ (US); Zhengzhang Chen, Princeton Junction, NJ (US); Haifeng Chen, West Windsor, NJ (US)

(21) Appl. No.: 19/202,700

(22) Filed: May 8, 2025

Related U.S. Application Data
(60) Provisional application No. 63/647,122, filed on May 14, 2024.
(60) Provisional application No. 63/649,996, filed on May 21, 2024.

(51) Int. Cl. G06F 18/2431; G06F 18/25

(52) U.S. Cl. CPC G06F 18/2431; G06F 18/254

(57) ABSTRACT

Methods and systems for classification include performing multi-label classification on an input using a trained model to generate classification outputs corresponding to respective labels. The classification outputs are fused to generate a joint opinion. It is determined that the input is out of distribution as compared to a training dataset of the trained model based on a joint belief of the joint opinion. An action is performed responsive to the determination that the input is out of distribution.

### RELATED APPLICATION INFORMATION

This application claims priority to U.S. Application No. 63/647,122, filed on May 14, 2024, and to U.S. Application No. 63/649,996, filed on May 21, 2024, each incorporated herein by reference in its entirety.

### BACKGROUND

### Technical Field

The present invention relates to machine learning models and, more particularly, to multi-label classification.

### Description of the Related Art

Multi-label classification is a task that can be performed by machine learning models, where an instance may belong to multiple categories. When performing classification in complex domains, the out-of-distribution arises when a model encounters data points that differ from the distribution of training data. This leads to unreliable predictions and undermines the model's utility.

Efforts have been made to distinguish out-of-distribution samples from in-distribution samples, but they do not extend well to a multi-label context.

### SUMMARY

A method for classification includes performing multi-label classification on an input using a trained model to generate classification outputs corresponding to respective labels. The classification outputs are fused to generate a joint opinion. It is determined that the input is out of distribution as compared to a training dataset of the trained model based on a joint belief of the joint opinion. An action is performed responsive to the determination that the input is out of distribution.

A system for classification includes a hardware processor and a memory that stores a computer program. When executed by the hardware processor, the computer program causes the hardware processor to perform multi-label classification on an input using a trained model to generate a plurality of classification outputs corresponding to respective labels, to fuse the plurality of classification outputs to generate a joint opinion, to determine that the input is out of distribution as compared to a training dataset of the trained model based on a joint belief of the joint opinion, and to perform an action responsive to the determination that the input is out of distribution.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an exemplary scene for a self-driving vehicle, in accordance with an embodiment of the present invention;

FIG. 2 is a diagram of systems within a self-driving vehicle, in accordance with an embodiment of the present invention;

FIG. 3 is a block/flow diagram of a method for detecting and responding to an out-of-distribution input for a trained model, in accordance with an embodiment of the present invention;

FIG. 4 is a block diagram of a computing device that can detect and respond to out-of-distribution inputs, in accordance with an embodiment of the present invention;

FIG. 5 is a diagram of an exemplary neural network architecture that can be used to implement part of a machine learning model, in accordance with an embodiment of the present invention; and

FIG. 6 is a diagram of an exemplary deep neural network architecture that can be used to implement part of a machine learning model, in accordance with an embodiment of the present invention.

### DETAILED DESCRIPTION OF PREFERRED EMBODIMENTS

Evidential neural network models can be used to estimate the evidence supporting a label for a multi-label classification task, thereby enabling the model to quantify an uncertainty associated with its predictions. A joint belief framework is used for multi-label opinion fusion through comultiplication. This approach integrates multiple label evidence sources, providing accurate and cohesive predictions.

Multi-label classification can be used in a variety of applications, such as in computer vision. As an example, the sensors of a self-driving vehicle collect information about the environment. These sensors may include cameras and light direction and ranging (LIDAR) sensors that image the area around the vehicle. Multi-label classification may be used to identify people, vehicle, and objects within the scene. This information is then used to make decisions regarding the actions of the self-driving vehicle. For example, identifying a curb or traffic control device will have different effects on the actions of the vehicle than the presence of a pedestrian. Improvements to the reliability of the model's labels will improve the performance and safety of the self-driving car's decision making.

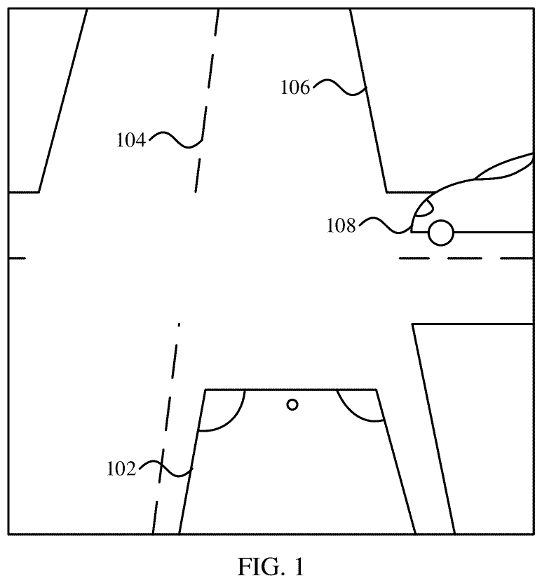

Referring now to FIG. 1, an example road scene is shown. The scene may be captured by a camera that is mounted on a vehicle 102, and may show the surroundings of the vehicle 102 from a particular perspective. It should be understood that multiple such images may be used to show various perspectives, to ensure awareness of the vehicle's entire surroundings. In some cases, a panoramic or 360° camera may be used.

Multi-label classification may be used to identify objects within the scene. For example, the road may have markings 104 and a curb or barrier 106. Other vehicles 108 may be present in the scene, along with pedestrians, animals, and other mobile and stationary objects. The classification may identify a given object using one of a set of appropriate labels, and in some cases a given object may be identified according to multiple labels. Using this information, a navigation or self-driving system in the vehicle 102 can safely navigate through the scene.

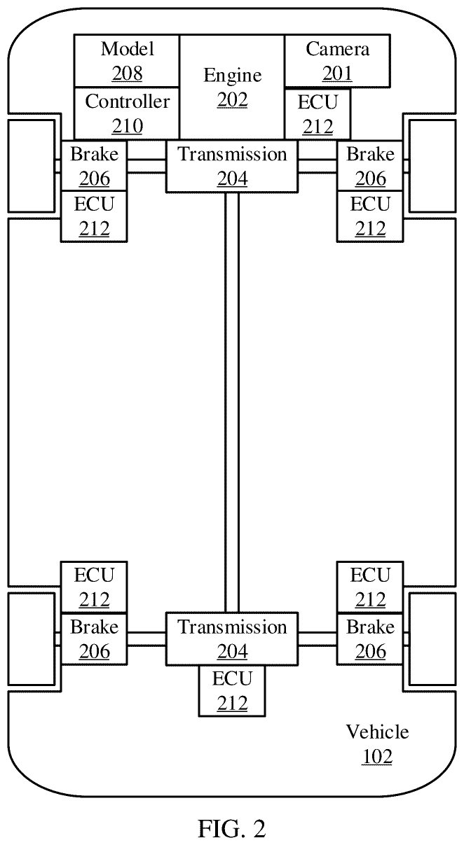

Referring now to FIG. 2, additional detail on a vehicle 102 is shown. A number of different sub-systems of the vehicle 102 are shown, including an engine 202, a transmission 204, and brakes 206. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is controlled by one or more equipment control units (ECUs) 212, which perform measurements of the state of the respective sub-system. For example, ECUs 212 relating to the brakes 206 may control an amount of pressure that is applied by the brakes 206. An ECU 212 associated with the wheels may further control the direction of the wheels. The information that is gathered by the ECUs 212 is supplied to the controller 210. A camera 201 or other sensor (e.g., LiDAR or RADAR) can be used to collect information about the surrounding road scene, and such information may also be supplied to the controller 210.

Communications between ECUs 212 and the sub-systems of the vehicle 102 may be conveyed by any appropriate wired or wireless communications medium and protocol. For example, a car area network (CAN) may be used for communication. The time series information may be communicated from the ECUs 212 to the controller 210, and instructions from the controller 210 may be communicated to the respective sub-systems of the vehicle 102.

The controller 210 uses the output of the object detection model 208, based on information collected from cameras 201, to identify objects and hazards within the scene. The model 208 may, for example, output a labeled image of a road scene that is labeled according to objects and hazards that have been detected.

The controller 210 may communicate internally to the sub-systems of the vehicle 22 and the ECUs 212. Based on detected road fault information, the controller 210 may communicate instructions to the ECUs 212 to avoid a hazardous road condition. For example, the controller 210 may automatically trigger the brakes 206 to slow down the vehicle 22 and may furthermore provide steering information to the wheels to cause the vehicle 22 to move around a hazard.

The model 208 may include a multi-label classifier, which may label detected objects according to a plurality of different labels. The model 208 thus takes an input as an image and may generate an output that includes a set of bounding boxes that localize objects in the image. Each bounding box may come with a label vector that indicates which labels apply to the object.

One example of a downstream task for object detection is a planner, which takes output of the multi-label classification as its input. The output may include localized objects in the scene along with labels. Using labels that have a high accuracy, controller 210 can perform driving actions to maintain safety.

Evidential learning can be used to quantify classification uncertainty, which simultaneously models the probability of each class and overall uncertainty of the current prediction. In the context of multi-class classification, subjective logic (SL) is a type of probabilistic logic that explicitly takes epistemic uncertainty and source trust into account. Epistemic uncertainty measures whether given input data exists within the distribution of data used for training. For a multiclass setting, a multinomial opinion of a random variable y is represented by ω=(b, u, a) with domain [symbol] ={1, . . . , K}, where b indicates belief mass distribution, u indicates uncertainty with a lack of evidence, and a indicates base rate distribution. The term evidence indicates how much data supports a particular classification of a sample based on the observations it contains. For a K multi-class setting, the probability mass p=[p₁,p₂, . . . ,p_{K}] is assumed to follow a Dirichlet distribution parameterised by a K-dimensional Dirichlet strength vector α={α₁, . . . , α_{K}}. However, this assumption is not available for multi-label setting since probabilities of classification follow multiple binomial distributions, not a categorical distribution. A Beta distribution may be used, as the conjugate prior of binomial distribution, which can provide binary evidence for each class:

$$Beta ( p \vert α , β ) = \{ \begin{matrix}\frac{1}{β ( α + β )} {{p}^{α - 1} ( 1 - p )}^{β - 1} , & for p ∈ [ 0 , 1 ] \\ 0 , & otherwise\end{matrix}$$

where β is strength vector and the probability mass p∈[0,1] is assumed to follow a Beta distribution parameterised by a 2-dimensional strength vector [α, β]. B(α, β) is a 2-dimensional Beta function. Each binomial classification w holds a binomial opinion:

$$ω = ( b , d , u , a )$$

with domain [symbol] ={0,1}, where b indicates belief mass distribution, d indicates disbelief mass distribution, u indicates uncertainty with a lack of evidence, and a indicates base rate distribution.

Let e={eₚₒₛ, e_{neg}} be the evidence for one binomial classification, where the positive evidence eₚₒₛ≥0 and the negative evidence e_{neg}≥0. The Beta strength [a, ß] is linked by the following α=eₚₒₛ+aW and β=e_{neg}+aW, where W is the weight of uncertain evidence. With loss of generality, the weight W is set to 2 and considering the assumption of the subjective opinion that a=½, then the Beta strength α=eₚₒₛ+1, β=e_{neg}+1. The total strength of the Beta is defined as S=α+β. Then the Beta evidence can be mapped to the subjective opinion by setting the following equality's:

$$b = \frac{α - 1}{α + β} ,$$

$$d = \frac{β - 1}{α + β} ,$$

$$u = \frac{2}{S} = \frac{2}{α + β} .$$

The output of traditional neural network classifiers can be considered as a point on a simplex, while Beta distribution parametrizes the density of each such probability assignment on a simplex. Therefore, with the Beta distribution, SL models the second-order probability and uncertainty of the output. The softmax function is widely used in the last layer of traditional neural network classifiers. However, using the softmax (or sigmoid) output as the confidence often leads to over-confidence. The introduced SL can avoid this problem by adding overall uncertainty mass.

After introducing evidence and uncertainty (i.e., opinion) for each class of multi-label, the class-wise opinion may be fused into a multi-label opinion. The opinion may be formed as a tuple of belief, disbelief, and uncertainty. The Dempster-Shafer theory of evidence allows evidence from different class to be fused arriving at a degree of belief that takes into account all the available evidence. Specifically, K different class domain sets of probability mass assignments

$${\{ {ω}_{k} \}}_{1}^{K}$$

may be fused, where ωₖ={bₖ, dₖ, uₖ, aₖ}, to obtain a joint mass Ω={b, d, u, a}.

Dempster's Comultiplication rule for two different class domain of masses can be defined by letting [symbol] ₘ={0,1} and [symbol] ₙ={0,1} be two different class domain, and letting ωₘ=(bₘ, dₘ, uₘ, aₘ) and ωₙ=(bₙ, dₙ, uₙ, aₙ) be binomial opinions on [symbol] ₘ and [symbol] ₙ. The fusion (called the joint mass) Ω={b, d, u, a} is calculated from the two sets of masses ωₘ and ωₙ in the following manner:

$$Ω = {ω}_{m} ⊕ {ω}_{n}$$

The more specific calculation rule can be formulated as follows:

$$\{ \begin{matrix}b = {b}_{m} + {b}_{n} - {b}_{m} {b}_{n} \\ d = {d}_{m} {d}_{n} + \frac{{a}_{m} ( 1 - {a}_{n} ) {d}_{m} {u}_{n} + ( 1 - {a}_{m} ) {a}_{n} {u}_{m} {d}_{n}}{{a}_{m} + {a}_{n} - {a}_{m} {a}_{n}} \\ u = {u}_{m} {u}_{n} + \frac{{a}_{n} {d}_{m} {u}_{n} + {a}_{m} {u}_{m} {d}_{n}}{{a}_{m} + {a}_{n} - {a}_{m} {a}_{n}} \\ a = {a}_{m} + {a}_{n} - {a}_{m} {a}_{n}\end{matrix} ,$$

Then, given K different class domain, the above-mentioned mass for the class domain can be obtained. Afterward, the opinions from different class domains can be combined with Dempster's rule of comultiplication. Specifically, the opinion mass between different class domains can be fused with the rule:

$$Ω = {ω}_{1} ⊕ {ω}_{2} ⊕ … {ω}_{K}$$

The joint operation Ω is formed based on the fusion of opinions ω₁, ω₂, . . . , ω_{K}, which represent the opinion of prediction for any existing class domain of multi-label classification. The comultiplication rule ensures that, if any class belief is high, the fused belief b will be high, and that only when all class beliefs are low will the fused belief b be low.

After obtaining the joint mass Ω, the corresponding joint evidence from different class domain and the parameters of the Beta distribution are induced as

$${e}_{pos} = \frac{b}{2 u} , {e}_{neg} = \frac{d}{2 u} , α = {e}_{pos} + 1 , β = {e}_{neg} + 1$$

Given K different class domain opinions {ω₁, ω₂, . . . , ω_{K}}, then b=0 only when b₁=b₂, . . . , b_{K}=0, where the joint belief b can be calculated iteratively. Only samples which do not belong to any known classes will have a relative low joint belief, which can effectively differentiate them from in-distribution sample. Thus, the joint belief is used to distinguish whether a sample is out-of-distribution (OOD). With a higher joint belief, a sample may be more confidently considered to be an in-distribution sample. A threshold value may be used to discriminate between in-distribution and out-of-distribution joint belief values.

Further, a multi-label classification opinion 22 can be formulated as a combination of K binomial classification opinions {ω₁, . . . , ωₖ, . . . , ω_{K}}. Each binomial classification ωₖ holds a binomial opinion ωₖ=(bₖ, dₖ, uₖ, aₖ) with domain [symbol] ₖ={0,1}, bₖ indicates positive belief mass distribution, dₖ indicates negative belief mass distribution, uₖ indicates uncertainty with a lack of evidence, and aₖ indicates base rate distribution.

Compared with classical neural networks, Evidential Neural Networks (ENNs) do not have a softmax layer, but may instead use an activation layer such as a rectified linear unit (ReLU) to make sure that the output is non-negative. To be specific, Multi-Label Classification (TMLC) is built by stacking multi-layer perceptron (MLP) layers and two fully connected layers (FCs) and ReLU layers, which are taken as the positive and negative evidence vectors for Beta distribution respectively.

Given sample i, let fₚₒₛ(X,A|θ) and f_{neg}(X,A|θ) represent the positive and negative evidence vectors predicted by multi-label evidential graph neural networks (EGNNs), where X is the input node feature matrix, A is the adjacency matrix, and θ represents the network parameters. Then, the two parameters αᵢ=[αᵢ₁, . . . , αᵢₖ, . . . , α_{iK}] and βᵢ=[βᵢ₁, . . . , βᵢₖ, . . . , β_{iK}] of Beta distribution for node i:

$${α}_{i} = {f}_{pos} ( X , A \vert θ ) + 1$$

$${β}_{i} = {f}_{neg} ( X , A \vert θ ) + 1 .$$

where k indicates the k-th class of total K classes.

With N training samples and K different classes, a multi-label evidential neural network is trained by minimizing the Beta loss:

$${ℒ}_{Beta} = {\sum }_{i = 1}^{N} {\sum }_{k = 1}^{K} \int [ BCE ( {y}_{ik} , {p}_{ik} ) ] B ( {α}_{ik} , {β}_{ik} ) {dp}_{ik} = {\sum }_{i = 1}^{N} {\sum }_{k = 1}^{K} \int [ - {y}_{ik} log ( {p}_{ik} ) - ( 1 - {y}_{ik} ) log ( 1 - {p}_{ik} ) ] B ( {α}_{ik} , {β}_{ik} ) {dp}_{ik} = {\sum }_{i = 1}^{N} {\sum }_{k = 1}^{K} [ - {y}_{ik} 𝔼 [ log ( {p}_{ik} ) ] - ( 1 - {y}_{ik} ) 𝔼 [ log ( 1 - {p}_{ik} ) ] ]$$

where B(αᵢₖ, βᵢₖ) is a 2-dimensional Beta function. BCE(⋅) denotes the Binary Cross Entropy Loss. pᵢₖ represents the predicted probability of sample i belonging to class k by model. yᵢₖ represents the ground truth for sample i with label k, i.e., yᵢₖ=1 means the training node i belongs to class k, otherwise yᵢₖ=0. [symbol] [⋅] is used to represent [symbol] ₚ_{ᵢₖ}_{˜Beta}[⋅]. To be specific,

$${𝔼}_{{p}_{ik} ∼ Beta} [ log ( {p}_{ik} ) ] = ψ ( {α}_{ik} ) - ψ ( {α}_{ik} + {β}_{ik} ) ,$$

$${𝔼}_{{p}_{ik} ∼ Beta} [ log ( 1 - {p}_{ik} ) ] = ψ ( {β}_{ik} ) - ψ ( {α}_{ik} + {β}_{ik} )$$

where Γ(⋅) is the Gamma function. Thus, the Beta loss term [symbol] _{Beta} is:

$${ℒ}_{Beta} = {\sum }_{j = 1}^{N} {\sum }_{i = 1}^{K} [ {y}_{ij} ( ψ ( {α}_{ij} + {β}_{ij} ) - ψ ( {α}_{ij} ) ) + ( 1 - {y}_{ij} ) ( ψ ( {α}_{ij} + {β}_{ij} ) - ψ ( {β}_{ij} ) ) ]$$

where ψ(⋅) denotes the Digamma function. As the belief and disbelief of label k for sample i:

$${b}_{ik} = \frac{{α}_{ik} - 1}{{α}_{ik} + {β}_{ik}} , {d}_{ik} = \frac{{β}_{ik} - 1}{{α}_{ik} + {β}_{ik}}$$

For in-distribution multi-label classification, the positive belief is set as the probability of class i for sample j, i.e.,

$$\frac{{α}_{ik} - 1}{{α}_{ik} + {β}_{ik}} ,$$

without additional time consumption.

Multi-class and multi-label OOD detection are connected, but different tasks. For the multi-class OOD example, there are a few pieces of evidence for each class such that a vacuity uncertainty will arise. For the multi-label OOD setting, the Beta distribution may be predicted for each class for the multi-label OOD detection. Since the OOD example does not belong to any in-distribution class, the ideal Beta distribution for each class will be estimated as having zero positive evidence and large negative evidence. Therefore, the vacuity uncertainty for each class will be a small value due to the large negative evidence, which cannot distinguish the in-distribution and OOD sample in the multi-label setting. From another perspective, most in-distribution nodes only belong to a few different classes, so much negative evidence occurs in other classes.

Therefore, it is difficult to distinguish the in-distribution and OOD samples based on negative evidence. Moreover, the positive evidence for each class in the OOD node is all zero, which is different from ID nodes and might help to detect multi-label OOD nodes. Due to the importance of positive evidence in multi-label OOD detection, in the following sections, KNPE and multi-label opinions fusion techniques may be used to further improve the positive evidence estimation in both training and inference phases.

The loss function [symbol] _{Beta} ensures that the correct label of each sample generates more evidence than other classes. However, it cannot guarantee that less evidence will be generated for incorrect labels. To help ensure that evidence for incorrect labels will shrink to zero, a Kullback-Leibler divergence term may be used:

$$KL [ D ( {p}_{i} \vert {\tilde{α}}_{i} ) ‖ D ( {p}_{i} \vert 1 ) ] = log ( \frac{Γ ( {\sum }_{k = 1}^{K} {\tilde{α}}_{ik} )}{Γ ( K ) {\prod }_{k = 1}^{K} Γ ( {\tilde{α}}_{ik} )} ) + {\sum }_{k = 1}^{K} ( {\tilde{α}}_{ik} - 1 ) [ ψ ( {\tilde{α}}_{ik} ) - ψ ( {\sum }_{j = 1}^{K} {\tilde{α}}_{ij} ) ]$$

where \tilde{α}ᵢ=yᵢ+(1−yᵢ)⊙αᵢ is the adjusted parameter of the Dirichlet distribution which can avoid penalizing the evidence of the groundtruth class to 0, and Γ(⋅) is the gamma function. Therefore, given parameter αᵢ of the Dirichlet distribution for each sample i, the sample-specific loss is

$$ℒ ( {α}_{i} ) = {ℒ}_{Bcta} ( {α}_{i} ) + {λ}_{t} KL [ D ( {p}_{i} \vert {\tilde{α}}_{i} ) ‖ D ( {p}_{i} \vert 1 ) ] ,$$

where λₜ>0 is the balance factor. In practice, the value of λₜ can be increased gradually so as to prevent the network from paying too much attention to the KL divergence in the initial stage of training, which might otherwise result in a lack of good exploration of the parameter space and cause the network to output a flat uniform distribution.

To ensure that all classes can simultaneously form reasonable opinions and thus improve the overall opinion, a multi-task strategy may be used with the following overall loss function:

$${ℒ}_{overall} = {\sum }_{i = 1}^{N} [ ℒ ( {α}_{i} ) + {\sum }_{k = 1}^{K} ℒ ( {α}_{i}^{k} ) ]$$

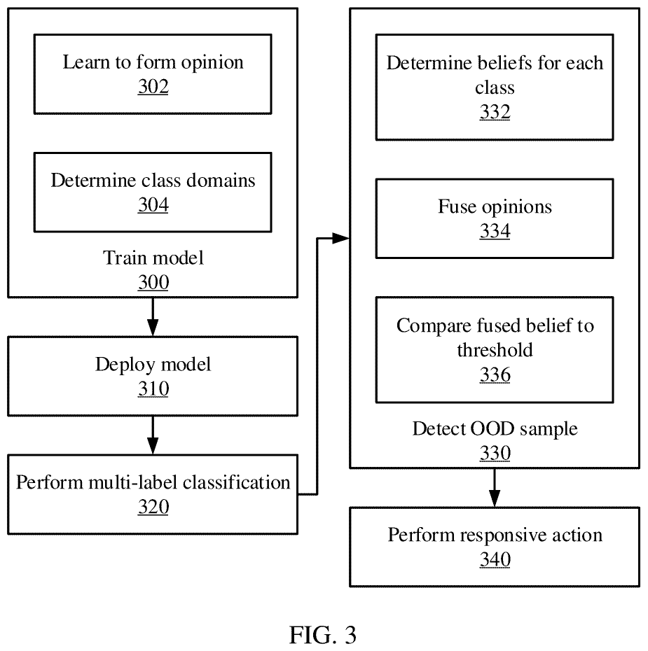

Referring now to FIG. 3, a method of training and using a multi-label classification model is shown. Block 300 trains the multi-classification model to form opinions about an input sample. The training 302 uses a training dataset to perform this training, as described above. Block 304 determines class domains relating to the labels of the classification. The training 302 causes the model to output opinions that each include a belief value.

Block 310 deploys the model to a target system, where it will be used to perform inference on new data. Deployment 310 may include copying the parameters of the trained model to the target system. In embodiments where the inference will be performed at the same system as training, the deployment 310 may be omitted.

Block 320 performs multi-label classification on a new input using the trained model. The model outputs a set of opinions for the different label classes. Block 330 then detects whether the new input was out of distribution relative to the training dataset. Block 332 determines the beliefs for each class, based on the output set of opinions. Block 334 fuses the opinions, including fusing the beliefs, to generate a fused belief. Block 336 then compares the fused belief to a threshold. If the fused belief is above the threshold, it is determined that the new input is well represented by the distribution of the training dataset. If the fused belief is below the threshold, then that means that no class has a confidence level high enough to be in the training distribution. It is therefore determined that the new input is out of distribution relative to the training dataset.

Block 340 performs a responsive action based on the classification output and the determination of whether the input was OOD. When the new input is determined to be OOD, the label(s) generated by the classification are not trustworthy. In the context of a self-driving vehicle, the detection of OOD inputs may represent a condition or object that was not included in the training dataset, such that making safe predictions is more difficult. An appropriate response may be to reduce speed or perform some other steering, braking, or acceleration action.

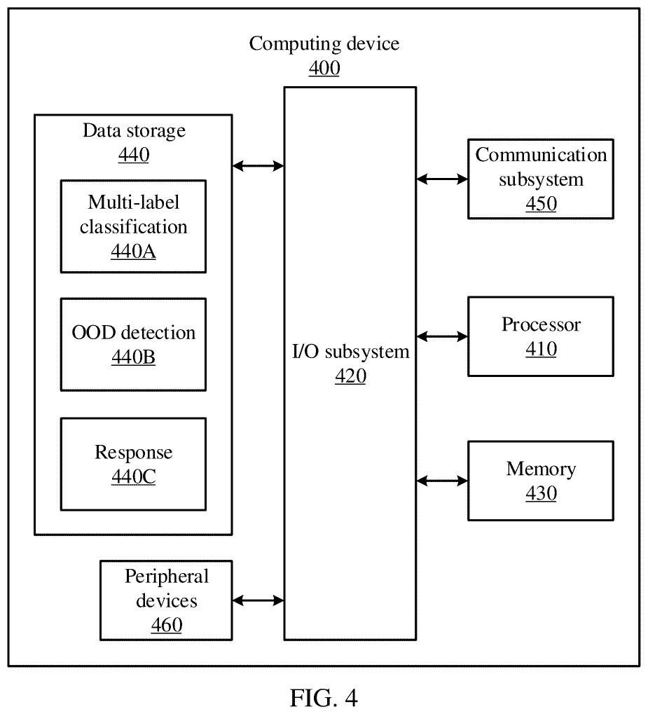

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for multi-label classification, 440B for detecting OOD samples, and/or 440C for performing a responsive action. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

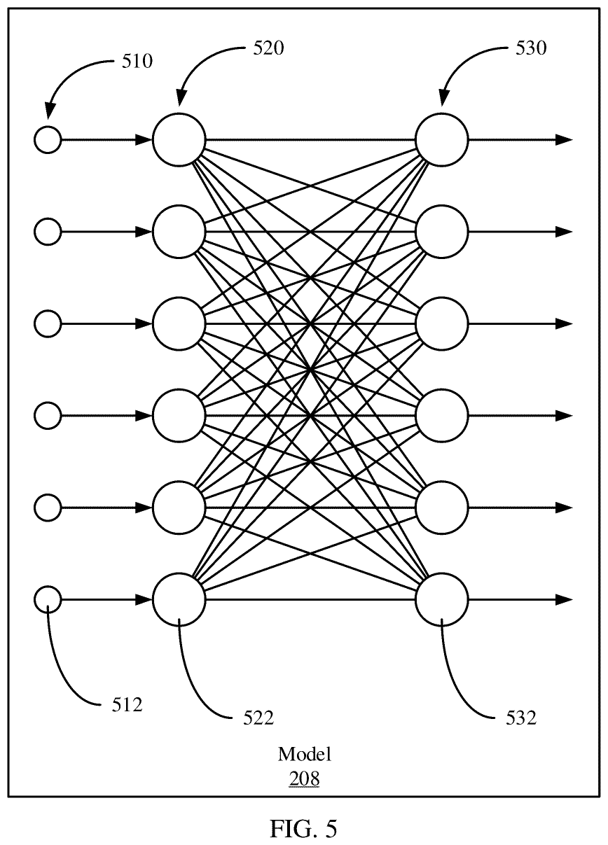

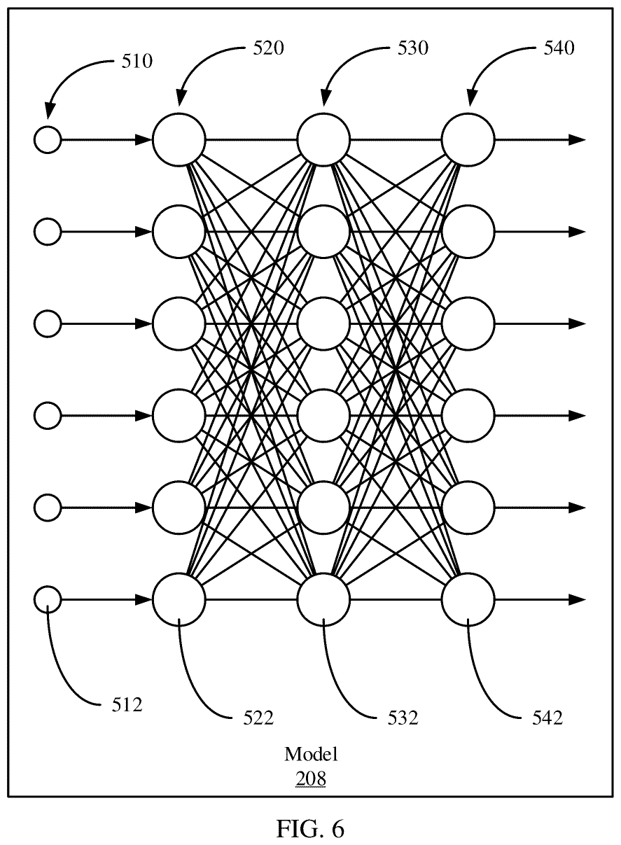

Referring now to FIGS. 5 and 6, exemplary neural network architectures are shown, which may be used to implement parts of the present models, such as the model 208. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for classification, comprising:
performing multi-label classification on an input using a trained model to generate a plurality of classification outputs corresponding to respective labels;
fusing the plurality of classification outputs to generate a joint opinion;
determining that the input is out of distribution as compared to a training dataset of the trained model based on a joint belief of the joint opinion; and
performing an action responsive to the determination that the input is out of distribution.

2. The method of claim 1, wherein the plurality of classification outputs each include a belief, a disbelief, and an uncertainty value.

3. The method of claim 2, wherein the belief, the disbelief, and the uncertainty value are determined as:
$$b = \frac{α - 1}{α + β} , d = \frac{β - 1}{α + β} , u = \frac{2}{α + β}$$
where α and β are strength vectors.

4. The method of claim 2, wherein fusing the plurality of classification outputs ω(b, d, u, a)=ωₘ(bₘ, dₘ, uₘ, aₘ)⊕ωₙ(bₙ, dₙ, uₙ, aₙ) is performed as:
$$\{ \begin{matrix}b = {b}_{m} + {b}_{n} - {b}_{m} {b}_{n} \\ d = {d}_{m} {d}_{n} + \frac{{a}_{m} ( 1 - {a}_{n} ) {d}_{m} {u}_{n} + ( 1 - {a}_{m} ) {a}_{n} {u}_{m} {d}_{n}}{{a}_{m} + {a}_{n} - {a}_{m} {a}_{n}} \\ u = {u}_{m} {u}_{n} + \frac{{a}_{n} {d}_{m} {u}_{n} + {a}_{m} {u}_{m} {d}_{n}}{{a}_{m} + {a}_{n} - {a}_{m} {a}_{n}} , \\ a = {a}_{m} + {a}_{n} - {a}_{m} {a}_{n}\end{matrix}$$
where b is the belief, d is the disbelief, u is the uncertainty, and a is a base rate distribution.

5. The method of claim 1, wherein determining that the input is out of distribution includes determining that the joint belief is below a threshold.

6. The method of claim 1, wherein a distribution of the training dataset is represented as a Beta distribution.

7. The method of claim 1, further comprising training the model using a Beta loss function combined with a Kullback-Leibler divergence.

8. The method of claim 7, wherein the training includes a training dataset that includes a plurality of in-distribution classes.

9. The method of claim 1, wherein the trained model is implemented using a machine learning model.

10. The method of claim 1, wherein the action is a driving action selected from the group consisting of steering, braking, and accelerating.

11. A system for classification, comprising:
a hardware processor; and
a memory that stores a computer program which, when executed by the hardware processor, causes the hardware processor to:
perform multi-label classification on an input using a trained model to generate a plurality of classification outputs corresponding to respective labels;
fuse the plurality of classification outputs to generate a joint opinion;
determine that the input is out of distribution as compared to a training dataset of the trained model based on a joint belief of the joint opinion; and
perform an action responsive to the determination that the input is out of distribution.

12. The system of claim 11, wherein the plurality of classification outputs each include a belief, a disbelief, and an uncertainty value.

13. The system of claim 12, wherein the belief, the disbelief, and the uncertainty value are determined as:
$$b = \frac{α - 1}{α + β} , d = \frac{β - 1}{α + β} , u = \frac{2}{α + β}$$
where α and β are strength vectors.

14. The system of claim 12, wherein fusion of the plurality of classification outputs ω(b, d, u, a)=ωₘ(bₘ, dₘ, uₘ, aₘ)⊕ωₙ(bₙ, dₙ, uₙ, aₙ) is performed as:
$$\{ \begin{matrix}b = {b}_{m} + {b}_{n} - {b}_{m} {b}_{n} \\ d = {d}_{m} {d}_{n} + \frac{{a}_{m} ( 1 - {a}_{n} ) {d}_{m} {u}_{n} + ( 1 - {a}_{m} ) {a}_{n} {u}_{m} {d}_{n}}{{a}_{m} + {a}_{n} - {a}_{m} {a}_{n}} \\ u = {u}_{m} {u}_{n} + \frac{{a}_{n} {d}_{m} {u}_{n} + {a}_{m} {u}_{m} {d}_{n}}{{a}_{m} + {a}_{n} - {a}_{m} {a}_{n}} , \\ a = {a}_{m} + {a}_{n} - {a}_{m} {a}_{n}\end{matrix}$$
where b is the belief, d is the disbelief, u is the uncertainty, and a is a base rate distribution.

15. The system of claim 11, wherein determination that the input is out of distribution includes determining that the joint belief is below a threshold.

16. The system of claim 11, wherein a distribution of the training dataset is represented as a Beta distribution.

17. The system of claim 11, wherein the computer program further causes the hardware processor to train the model using a Beta loss function combined with a Kullback-Leibler divergence.

18. The system of claim 17, wherein the training includes a training dataset that includes a plurality of in-distribution classes.

19. The system of claim 11, wherein the trained model is implemented using a machine learning model.

20. The system of claim 11, wherein the action is a driving action selected from the group consisting of steering, braking, and accelerating.
